(19) United States
(12) Patent Application Publication
(10) Pub. No.: US 2025/0266012 A1
(43) Pub. Date: Aug. 21, 2025

(54) DRIVER CIRCUIT AND IMAGE DISPLAY SYSTEM

(71) Applicant: ROHM Co., Ltd., Kyoto (JP)

(72) Inventor: Hiroyoshi ICHIKURA, Yokohama (JP)

(73) Assignee: ROHM Co., Ltd., Kyoto (JP)

(21) Appl. No.: 19/052,254

(22) Filed: Feb. 12, 2025

(30) Foreign Application Priority Data
Feb. 21, 2024 (JP) 2024-024927

(51) Int. Cl. G09G 3/36; G09G 3/00; G09G 3/20

(52) U.S. Cl. CPC G09G 3/3688; G09G 3/006; G09G 3/2092; G09G 2310/0286; G09G 2310/08; G09G 2330/06; G09G 2330/12

(57) ABSTRACT

A driver circuit that displays received display data on a display panel is provided. The driver circuit includes: a first register circuit, holding display control data used for controlling display of the display data on a display panel and outputting the display control data at a predetermined timing; multiple second register circuits, holding decision data with predetermined logic; a decision circuit, outputting a decision result indicating no abnormality has occurred in response to a logic of decision data held in second register circuits being a predetermined logic, respectively, and display control data held in the first register circuit being active; and a mask control circuit, controlling so that display control data held in the first register circuit is output to a circuit that performs display control of the display panel in response to a decision result output from the decision circuit indicating that no abnormality has occurred.

### CROSS-REFERENCE TO RELATED APPLICATION

This application claims the priority benefits of Japanese application no. 2024-024927, filed on Feb. 21, 2024. The entirety of the above-mentioned patent application is hereby incorporated by reference herein and made a part of this specification.

### BACKGROUND

### Technical Field

The disclosure relates to a driver circuit (driver IC) for driving a liquid crystal display device such as an LCD (Liquid Crystal Display).

### Description of Related Art

In recent years, various information processing devices such as personal computers and mobile phone devices use liquid crystal display devices such as LCDs as display devices. To display display data on such liquid crystal display devices, driver circuits (driver ICs) are used to drive the liquid crystal display devices (for example, refer to Patent Document 1 (Japanese Patent Application Laid-Open (JP-A) No. 2009-145492)).

In driver ICs for driving liquid crystal display devices as described above, display control is performed by writing display data line by line based on display control data such as source load pulse signals and abnormality detection signals.

However, due to the influence of external noise such as ESD (electro static discharge) noise, in the case where the display control data written in register circuits such as flip-flop circuits inside the driver IC is altered or destroyed, it may affect the displayed image and prevent normal image display from being performed. Thus, driver ICs with improved EMS (electro magnetic susceptibility) characteristics are desired.

Thus, to prevent such abnormalities in image display, a method has been proposed in which an external device that sends display data to the driver IC reads out and collates data stored inside the driver IC, and in the case where the data has changed from what should have been written, it is determined that an abnormality has occurred, and measures such as rewriting the display data to the driver IC are taken (for example, refer to Patent Document 2 (Japanese Patent No. 6712326)).

However, with a countermeasure method in which redisplay is performed after detecting the occurrence of an abnormality in the external device, there is a possibility that abnormal display has already occurred on the display panel by the time the external device detects the occurrence of the abnormality, making it difficult to completely prevent abnormal display from occurring on the display panel.

Thus, the disclosure provides a driver circuit and an image display system capable of reducing the possibility of abnormal display occurring due to incorrect display control data being output when displaying display data on a display panel based on display control data.

### SUMMARY

The driver circuit of the disclosure is a driver circuit that displays received display data on a display panel, including:
a first register circuit, holding display control data used for controlling display of the display data on a display panel and outputting the display control data at a predetermined timing;
a plurality of second register circuits, holding decision data with predetermined logic;
a decision circuit, outputting a decision result indicating no abnormality has occurred in response to a logic of decision data held in the plurality of second register circuits being a predetermined logic, respectively, and display control data held in the first register circuit being active; and
a mask control circuit, controlling so that display control data held in the first register circuit is output to a circuit that performs display control of the display panel in response to a decision result output from the decision circuit indicating that no abnormality has occurred.

### BRIEF DESCRIPTION OF THE DRAWINGS

FIG. 1 is a block diagram showing the overall configuration of the image display system according to the first embodiment of the disclosure.

FIG. 2 is a block diagram showing the configuration of the driver IC 10 according to the first embodiment of the disclosure.

FIG. 3 is a diagram for illustrating how incorrect output data is output using the output FF circuit 23 (33) that outputs the source load pulse signal and the abnormality detection signal.

FIG. 4 is a timing chart of the output FF circuit 23 (33) shown in FIG. 3.

FIG. 5 is a diagram showing the detailed configuration of the noise detection circuit 40 of the first embodiment of the disclosure shown in FIG. 2.

FIG. 6 is a timing chart for illustrating the operation of the noise detection circuit 40 in the first embodiment shown in FIG. 5.

FIG. 7 is a diagram showing the detailed configuration of the noise detection circuit 40A according to the second embodiment of the disclosure.

FIG. 8 is a diagram for illustrating the decision logic of the decision circuit 62 in FIG. 7.

FIG. 9 is a timing chart for illustrating the operation of the noise detection circuit 40A in the second embodiment shown in FIG. 7.

FIG. 10 is a diagram showing the circuit configuration in the case of performing cooperative operation by multiple noise detection circuits.

### DESCRIPTION OF THE EMBODIMENTS

Next, embodiments of the disclosure will be described in detail with reference to the drawings.

### First Embodiment

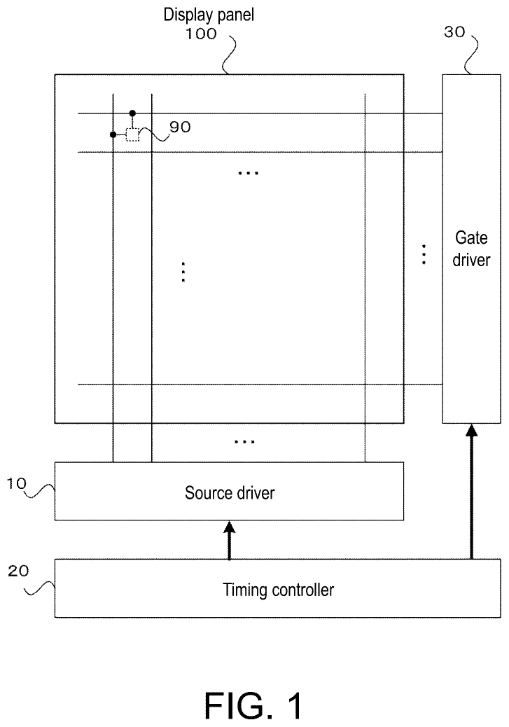

FIG. 1 is a block diagram showing an outline of the overall configuration of the image display system according to the first embodiment of the disclosure.

The image display system of this embodiment is configured to display an image on a display panel 100, and includes a source driver 10, a gate driver 30, and a timing controller 20. It is noted that the source driver 10 and the gate driver 30 may be configured to be built into the timing controller 20.

The display panel 100 is, for example, an active matrix type liquid crystal display device, in which display pixels 90 provided with pixel transistors such as thin-film transistors are arranged in a matrix. The display panel 100 includes scan lines connecting the display pixels 90 in the row direction and signal lines connecting the display pixels 90 in the column direction. The gate driver 30 is configured to sequentially set each scan line to a selection state, apply a predetermined signal voltage to each signal line via the source driver 10, and write a signal voltage corresponding to display data to the display pixels 90 in the selection state, thereby controlling the orientation state of the liquid crystal in each display pixel 90 to display a desired image. It is noted that the display panel 100 may be a display panel of another type, such as an organic EL (electro-luminescence) panel.

Here, the operation timing of the source driver 10 and the gate driver 30 is controlled by the timing controller 20. The timing controller 20 supplies control signals to the source driver 10 and the gate driver 30, respectively, for displaying a predetermined image on the display panel 100 based on a video signal supplied from an external source, thereby applying a predetermined voltage to the pixel electrodes of the display pixels 90 at a predetermined timing and controlling the display panel 100 to display an image based on the video signal. In other words, the timing controller 20 functions as a control circuit that transmits display data to the source driver 10.

Here, the source driver 10 is configured as a driver IC (driver circuit) that receives display data from the timing controller 20 and displays an image on the display panel 100 based on the received display data. Thus, in the subsequent description of this embodiment, the source driver 10 is described as the driver IC 10.

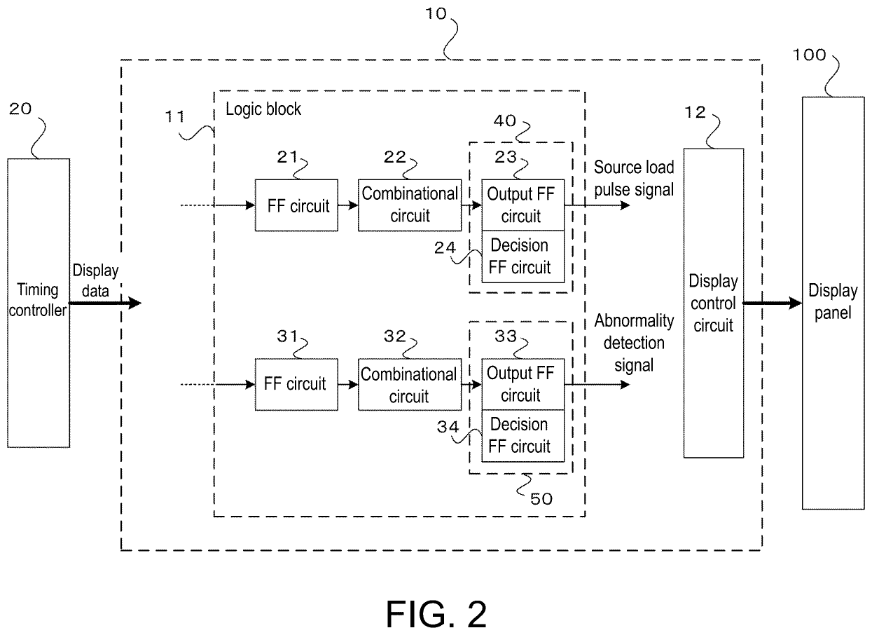

The configuration of the driver IC 10 in this embodiment is shown in the block diagram of FIG. 2. The driver IC 10 of this embodiment includes a logic block 11 and a display control circuit 12 internally.

The logic block 11 is configured with flip-flop circuits (hereinafter abbreviated as FF circuits) 21 and 31 that hold data, combinational circuits 22 and 32 that process data, and output FF circuits 23 and 33, and the like.

In the logic block 11, due to the circuit configuration described above, display control data such as a source load pulse signal and an abnormality detection signal are generated and output. The display control circuit 12 then performs display control of the display panel 100, such as a liquid crystal display device, by writing display data line by line based on these display control data.

In general, FF circuits may output incorrect output data when external noise, such as ESD noise, is superimposed on the input data.

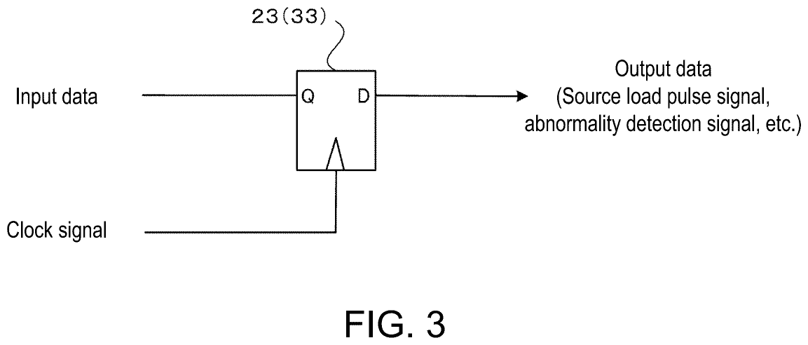

For example, the output of incorrect output data is described using an output FF circuit 23 (33) that outputs a source load pulse signal or an abnormality detection signal, as shown in FIG. 3.

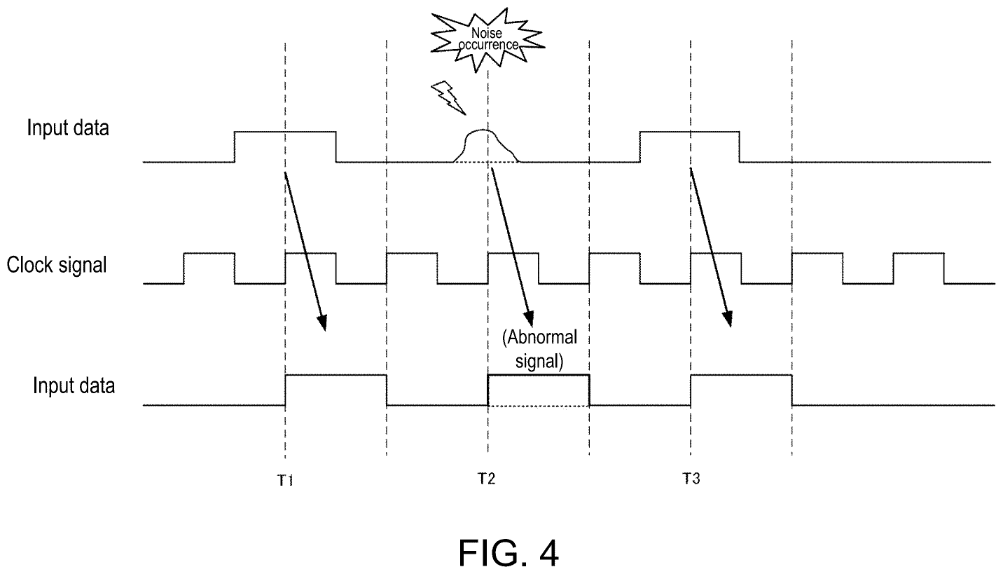

FIG. 4 shows a timing chart for the output FF circuit 23 (33) shown in FIG. 3. As shown in FIG. 4, the output FF circuit 23 (33) operates to hold the logic of the input data in synchronization with the rising edge of the clock signal and output the same as output data. At times T1 and T3 in FIG. 4, it is seen that a normal pulse signal is output as output data based on the pulse signal input as input data.

However, at time T2 in FIG. 4, it is seen that a pulse signal is output at a timing when it should not be output due to some noise superimposed on the input data. In the case where such an abnormal signal is output due to noise, the display control circuit 12 is unable to operate normally, and the image displayed on the display panel 100 may become abnormal in content.

For example, in the case where the source load pulse signal or the abnormality detection signal is output at a timing different from the normal timing, abnormal display is performed on the display panel 100.

Thus, in the driver IC 10 of this embodiment, as shown in FIG. 2, noise detection circuits 40 and 50 are configured by providing decision FF circuits 24 and 34 near the output FF circuits 23 and 33, respectively.

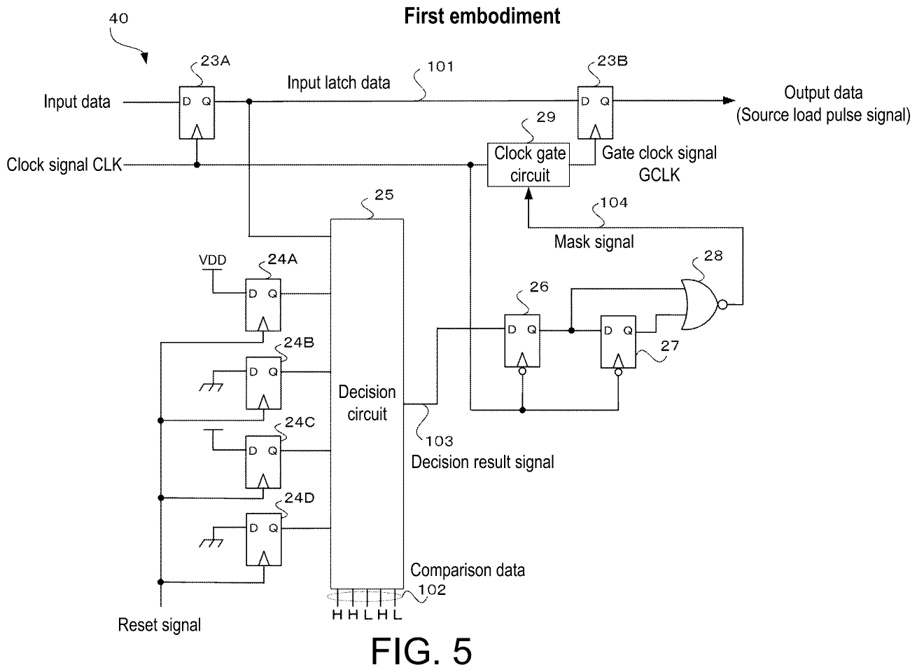

Next, FIG. 5 shows a detailed configuration of the noise detection circuit 40 of the first embodiment of the disclosure shown in FIG. 2. The circuit configuration of the noise detection circuit 50 provided in the circuit for generating the abnormality detection signal, and the circuit configuration of the noise detection circuits provided in the circuits for generating other display control signals, have similar circuit configurations to the noise detection circuit 40, so description thereof are omitted.

The noise detection circuit 40 includes, as shown in FIG. 5, output FF circuits 23A and 23B, decision FF circuits 24A to 24D, a decision circuit 25, FF circuits 26 and 27, a NOR circuit 28, and a clock gate circuit 29.

The output FF circuits 23A and 23B are register circuits that hold display control data, such as source load pulse signals used for controlling the display of display data on the display panel, and output the same at predetermined timings.

Specifically, the output FF circuit 23A holds the input data generated by the combinational circuit 22 and outputs the same as input latch data 101, while the output FF circuit 23B outputs this input latch data 101 as a source load pulse signal.

The decision FF circuits 24A to 24D are multiple second register circuits that hold decision data with predetermined logic. Specifically, decision FF circuits 24A and 24C are connected to VDD at their inputs, respectively, and in response to a reset signal input, they output high level (hereinafter abbreviated as H level) signals to the decision circuit 25. Further, decision FF circuits 24B and 24D are connected to GND at their inputs, and in response to a reset signal input, they output low level (hereinafter abbreviated as L level) signals to the decision circuit 25.

The decision circuit 25 outputs a decision result signal 103 indicating that no abnormality has occurred in the case where the logic of the decision data held in the four decision FF circuits 24A to 24D is set to the predetermined logic, and the input latch data 101 held in the output FF circuit 23A is at the H level, which is active.

Here, 5-bit data with the logic of H level, H level, L level, H level, and L level, respectively, is input to the decision circuit 25 as comparison data 102.

The decision circuit 25 compares this 5-bit comparison data 102 with the logic of the input latch data 101 and the logic of the decision data held in the four decision FF circuits 24A to 24D, in the case where all bits match, it outputs a decision result signal 103 at the H level, and in the case where even one bit does not match, it outputs a decision result signal 103 at the L level.

The FF circuits 26 and 27 operate in synchronization with the falling edge of the clock signal CLK. The FF circuit 26 receives the decision result signal 103 as input, and the FF circuit 27 receives the output of the FF circuit 26 as input. Then, the NOR circuit 28 outputs the denial result of the logical OR operation between the output of the FF circuit 26 and the output of the FF circuit 27 as the mask signal 104.

The FF circuits 26 and 27, the NOR circuit 28, and the clock gate circuit 29 constitute a mask control circuit that performs control to switch whether or not to output the clock signal CLK to the output FF circuit 23B as the gate clock signal GCLK based on the decision result signal 103.

This mask control circuit controls the output such that in response to the decision result signal 103 output from the decision circuit 25 indicating that no abnormality has occurred, the input latch data 101, which is the display control data held in the output FF circuit 23A, is output to the display control circuit 12 that performs display control of the display panel 100.

Specifically, the decision result signal 103 output from the decision circuit 25 is sequentially transferred to the FF circuit 26 and the FF circuit 27. Then, the output of the FF circuit 26 and the output of the FF circuit 27 are input to the NOR circuit 28 where a logical operation is performed to generate the mask signal 104.

The clock gate circuit 29 masks the clock signal CLK in response to the mask signal 104 being at H level, and outputs the clock signal CLK as the gate clock signal GCLK to the output FF circuit 23B in response to the mask signal 104 being at L level.

Due to the above-described circuit configuration of the mask control circuit, in response to the decision result signal 103 becoming H level, the mask signal 104 becomes L level for a period of two clock cycles of the clock signal CLK, and the gate clock signal GCLK for two clock cycles is supplied to the output FF circuit 23B. Then, the source load pulse signal based on the logic of the input latch data 101 is output from the output FF circuit 23B as output data.

In this way, in response to the decision result signal 103 output from the decision circuit 25 being at an H level indicating that no abnormality has occurred, the mask control circuit controls so that the clock signal CLK is supplied to the output FF circuit 23B, which outputs the input latch data 101, which is display control data held in the output FF circuit 23A, so that the input latch data 101 held in the output FF circuit 23A is output to the display control circuit 12, which controls the display of the display panel 100.

Then, in the case where the logic of at least one bit of the decision data held in the decision FF circuits 24A to 24D changes due to external noise such as ESD noise, in the decision circuit 25, the decision result signal 103 becomes L level, indicating that an abnormality has occurred, as the decision data no longer matches the comparison data 102. As a result, the mask signal 104 becomes H level, and the output data is also masked by masking the clock signal CLK.

It is noted that the 4-bit decision data held in the four decision FF circuits 24A to 24D includes at least one logic of both H level logic and L level logic. Specifically, the 4-bit decision data has a 4-bit logic of H level, L level, H level, and L level.

In this way, by using two types of decision FF circuits, namely decision FF circuits 24A and 24C which are expected to be at an H level when normal, and decision FF circuits 24B and 24D which are expected to be at an L level when normal, a configuration is achieved which is capable of detecting both negative noise on the power supply side and positive noise on the GND side.

Then, by configuring the four decision FF circuits 24A to 24D near the output FF circuits 23A and 23B, the accuracy of noise detection is improved, thereby reducing the risk of erroneous display.

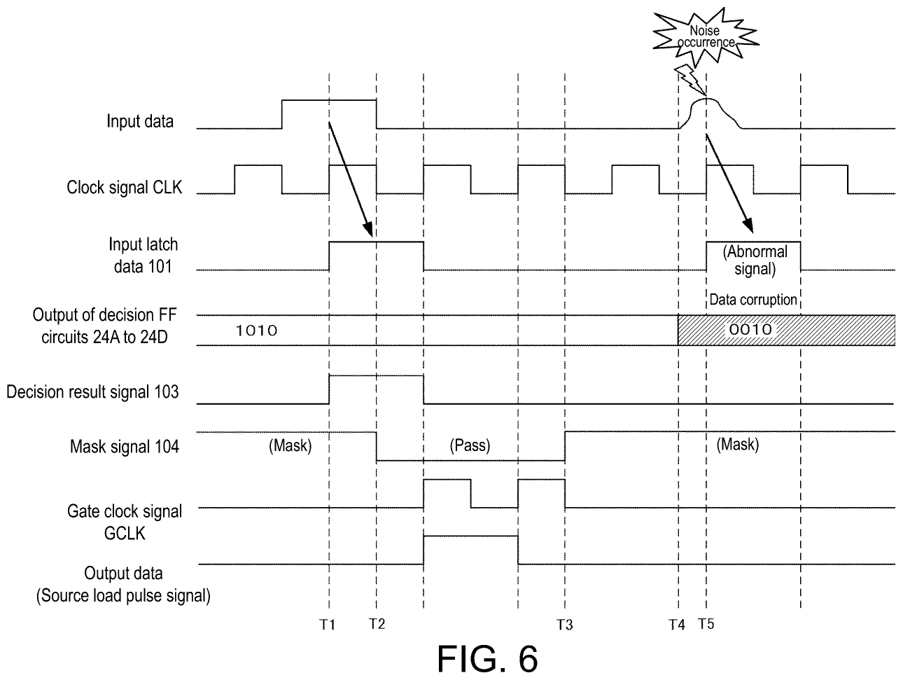

Next, the operation of the noise detection circuit 40 in the first embodiment shown in FIG. 5 is described with reference to the timing chart of FIG. 6.

In a normal state without noise occurrence, in response to the input data becoming H level at time T1 in FIG. 6, the input latch data 101 also becomes H level in synchronization with the rising edge of the clock signal CLK. Then, the combination of the input latch data 101 and the outputs (1010) of the decision FF circuits 24A to 24D becomes “11010”, which matches the logic “11010” of the comparison data 102. As a result, the decision circuit 25 changes the decision result signal 103 from L level to H level at time T1.

As a result of the decision result signal 103 becoming H level, the mask signal 104 becomes L level at time T2 and maintains the L level state for a period of two clock cycles (until time T3). Then, due to the mask signal 104 becoming L level, the clock gate circuit 29 releases the mask state of the clock signal CLK. In other words, the clock gate circuit 29 outputs two clock cycles of the clock signal CLK as the gate clock signal GCLK to the output FF circuit 23B. As a result, the output FF circuit 23B outputs the input latch data 101 as output data. This output data is output from the output FF circuit 23B as a source load pulse signal.

Next, the case where noise occurs at time T4, causing the input latch data 101 to change from L level to H level, and simultaneously, the outputs of the decision FF circuits 24A to 24D change from “1010” to “0010” is described.

In this case, even if the input latch data 101 becomes H level, the combination of the input latch data 101 and the outputs (0010) of the decision FF circuits 24A to 24D becomes “10010”, which does not match the logic “11010” of the comparison data 102.

Thus, the decision result signal 103 output from the decision circuit 25 remains at L level, and the mask signal 104 is maintained at H level. As a result, the clock gate circuit 29 keeps the clock signal CLK in the mask state, and no output data (source load pulse signal) is output from the output FF circuit 23B.

In the noise detection circuit 40 of this embodiment, in the case where one of the outputs from the four decision FF circuits 24A to 24D changes due to noise, the source load pulse signal is not output from the output FF circuit 23B, even if the input latch data 101 becomes H level.

Thus, according to the image display system of this embodiment, when displaying display data on the display panel 100 based on display control data such as the source load pulse signal, it becomes possible to reduce the possibility of abnormal display occurring due to the output of incorrect display control data.

### Second Embodiment

The following describes an image display system of the second embodiment of the disclosure.

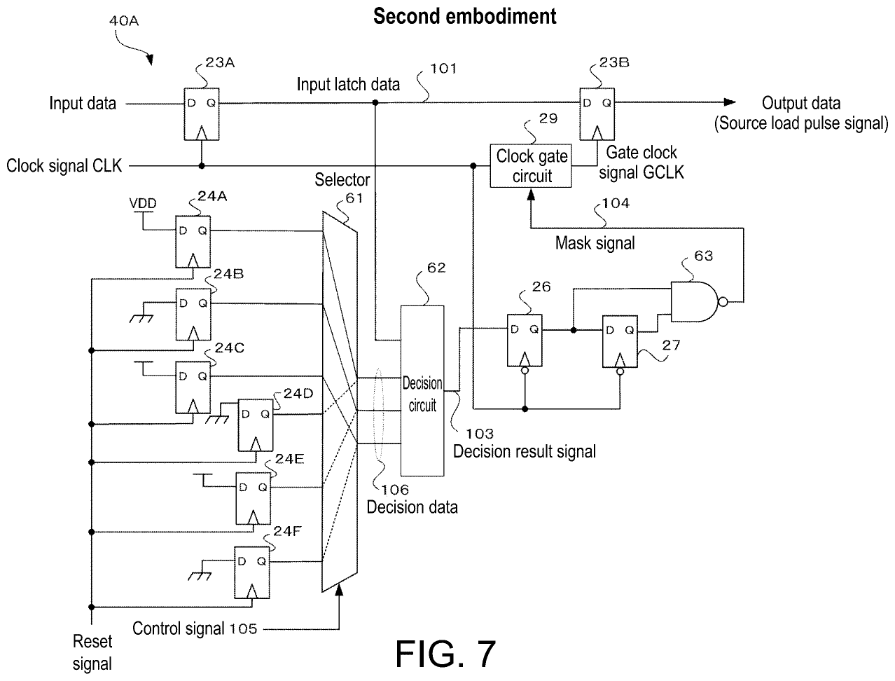

In the image display system of this embodiment, the noise detection circuit 40 is replaced with a noise detection circuit 40A as shown in FIG. 7. It is noted that in the image display system of this embodiment, the noise detection circuit 50 also has a circuit configuration as shown in FIG. 7, but the description thereof is omitted. Further, in the image display system of this embodiment, only the circuit configurations of the noise detection circuits 40 and 50 differ from those in the first embodiment, while other circuit configurations remain the same, so the description thereof are omitted.

The noise detection circuit 40A in this embodiment has a configuration where, compared to the noise detection circuit 40 in the first embodiment shown in FIG. 5, decision FF circuits 24E and 24F are added along with a selector 61, the decision circuit 25 is replaced with a decision circuit 62, and the NOR circuit 28 is replaced with a NAND circuit 63.

The decision FF circuits 24A to 24C are multiple second register circuits that hold decision data with predetermined logic. Further, the decision FF circuits 24D to 24F are multiple third register circuits that hold decision data with predetermined logic different from the decision data held in the decision FF circuits 24A to 24C. Specifically, the decision FF circuits 24A, 24C, and 24E have their inputs connected to VDD, respectively, so they output H level signals to the selector 61 in response to the input of a reset signal. Further, the decision FF circuits 24B, 24D, and 24F have their inputs connected to GND, so they output L level signals to the selector 61 in response to the input of a reset signal.

In other words, the decision data “101” is held in the decision FF circuits 24A to 24C, and the decision data “010” is held in the decision FF circuits 24D to 24F.

The selector 61 is a selection circuit that selects either the decision data held in the decision FF circuits 24A to 24C or the decision data held in the decision FF circuits 24D to 24F according to the logic of a control signal 105 that controls the timing at which the logic of the source load pulse signal switches, and outputs the selected data as decision data 106 to the decision circuit 62.

In this embodiment, it is assumed that the timing at which the input latch data 101 becomes H level is predetermined, and the circuit configuration is such that the control signal 105 also becomes H level at the timing when the input latch data 101 becomes H level.

Then, the selector 61, in the case where the control signal 105 is at H level, selects the decision data “010” from the decision FF circuits 24D to 24F and outputs the same as the decision data 106 to the decision circuit 62. Further, the selector 61, in the case where the control signal 105 is at L level, selects the decision data “101” from the decision FF circuits 24A to 24C and outputs the same as the decision data 106 to the decision circuit 62.

The decision circuit 62 outputs a decision result signal 103 indicating that no abnormality has occurred in the case where the combination of the logic of the decision data 106 selected by the selector 61 and the logic of the input latch data 101 held in the output FF circuit 23A matches any of the predetermined combinations.

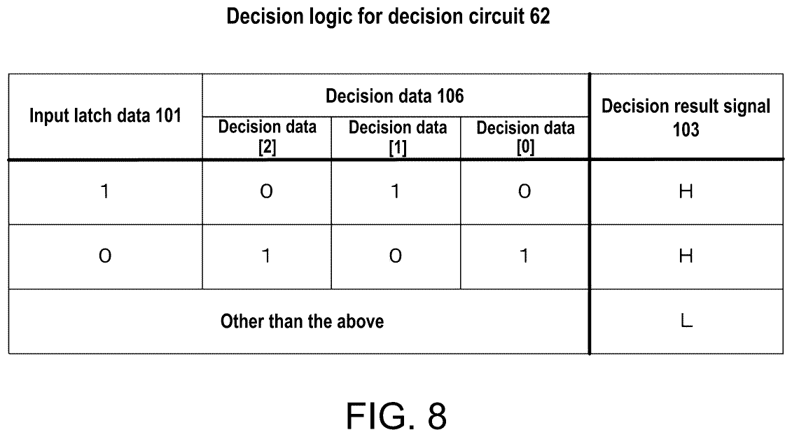

Specifically, the decision circuit 62 performs a decision based on the decision logic as shown in FIG. 8, according to the combination of the logic of the input latch data 101 and the logic of the decision data 106, and outputs the decision result as the decision result signal 103.

The decision logic of this decision circuit 62 is described with reference to FIG. 8. As shown in FIG. 8, the decision circuit 62 outputs a decision result signal 103 at H level in the case where the input latch data 101 is at H level (logic “1”) and the logic of the 3-bit decision data 106 is “010”.

Further, as shown in FIG. 8, the decision circuit 62 outputs a decision result signal 103 at H level in the case where the input latch data 101 is at L level (logic “0”) and the logic of the 3-bit decision data 106 is “101”.

Then, the decision circuit 62 outputs a decision result signal 103 at L level in cases where the combination of the logic of the input latch data 101 and the logic of the decision data 106 is other than those mentioned above.

In a normal state where no noise occurs, at the timing when the input latch data 101 becomes H level, the decision data of the decision FF circuits 24D to 24F is selected by the selector 61 and output as the decision data 106. Then, at the timing when the input latch data 101 becomes H level, the decision data of the decision FF circuits 24A to 24C is selected by the selector 61 and output as the decision data 106.

In other words, in a normal state where no noise occurs, the combination of the input latch data 101 and the decision data 106 input to the decision circuit 62 becomes either “1010” or “0101”. Thus, in a normal state where no noise occurs, the decision circuit 62 outputs a decision result signal 103 at H level.

Next, in the case where the combination of the input latch data 101 and the decision data 106 is neither “1010” nor “0101”, it is determined that an abnormality has occurred, and the decision result signal 103 is set to L level.

The FF circuit 26 receives the decision result signal 103 as input, and the FF circuit 27 receives the output of the FF circuit 26 as input. The NAND circuit 63 outputs the denial result of the logical AND operation between the output of the FF circuit 26 and the output of the FF circuit 27 as the mask signal 104.

It is noted that in this embodiment, the FF circuits 26 and 27, the NAND circuit 63, and the clock gate circuit 29 constitute a mask control circuit that performs control to switch whether or not to output the clock signal CLK to the output FF circuit 23B as the gate clock signal GCLK based on the decision result signal 103.

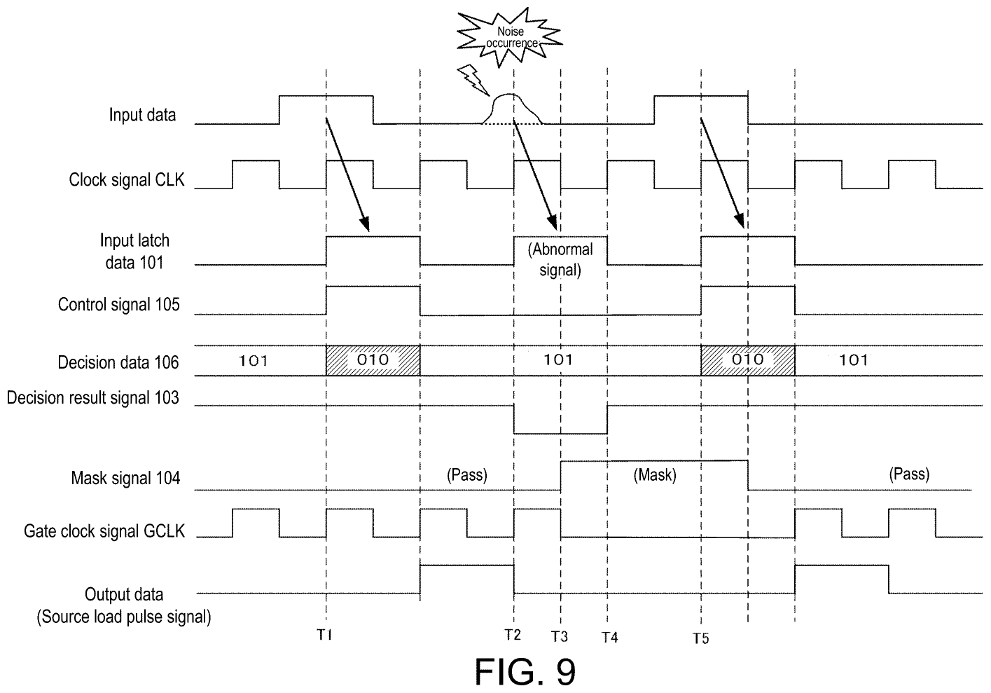

Next, the operation of the noise detection circuit 40A in the second embodiment shown in FIG. 7 is described using the timing chart shown in FIG. 9.

In the case where the input data is at L level and the input latch data 101 is also at L level, the control signal 105 is at L level. Thus, the selector 61 selects the decision data from the decision FF circuits 24A to 24C and outputs the same as the decision data 106 to the decision circuit 62. As a result, the decision circuit 62 outputs the decision result signal 103 at H level, the mask signal 104 becomes L level, and the clock signal CLK passes through the clock gate circuit 29 and is supplied to the output FF circuit 23B as the gate clock signal GCLK.

Then, in response to the input data becoming H level at times T1 and T5 in FIG. 9, the input latch data 101 also becomes H level in synchronization with the rising edge of the clock signal CLK. Next, since the control signal 105 is also at H level, the selector 61 selects the decision data from the decision FF circuits 24D to 24F and outputs the same as the decision data 106 to the decision circuit 62. As a result, the decision circuit 62 outputs the decision result signal 103 at H level, the mask signal 104 becomes L level, and the clock signal CLK passes through the clock gate circuit 29 and is supplied to the output FF circuit 23B as the gate clock signal GCLK.

Here, the operation in the case where noise occurs at time T2 in FIG. 9 is described. Due to the occurrence of noise at time T2, the input latch data 101 becomes H level despite the fact that the input data should originally be at L level. Then, since time T2 is not the timing at which the input data should originally become H level, the control signal 105 remains at L level. Thus, the selector 61 selects the decision data from the decision FF circuits 24A to 24C and outputs the same as the decision data 106 to the decision circuit 62.

Next, the decision circuit 62 receives the input latch data 101 at H level, and the data “101” is input as the decision data 106. As a result, the logic input to the decision circuit 62 becomes “1101”, and the decision circuit 62 outputs the decision result signal 103 at L level. Thus, at time T3, the mask signal 104 becomes H level, and the clock signal CLK is masked in the clock gate circuit 29, causing the gate clock signal GCLK to no longer be supplied to the output FF circuit 23B. As a result, the input latch data 101, which was generated as an abnormal signal due to the occurrence of noise, may be prevented from being output as output data.

In this way, the image display system of this embodiment also makes it possible to reduce the possibility of abnormal display being performed due to incorrect display control data being output when displaying display data on the display panel 100 based on display control data such as the source load pulse signal.

### Cooperative Operation by Multiple Noise Detection Circuits

In the above-described second embodiment, one noise detection circuit 40A detected the occurrence of noise to prevent the output of an incorrect source load pulse signal. However, in the case where noise occurs at any location within the driver IC 10, there is a high possibility that any circuit within the driver IC 10 may be malfunctioning.

Thus, in response to any of multiple noise detection circuits detecting the occurrence of noise, it may be arranged to stop not only the display control data output from the location where that noise detection circuit is provided, but also the display control data output from locations where other noise detection circuits are provided.

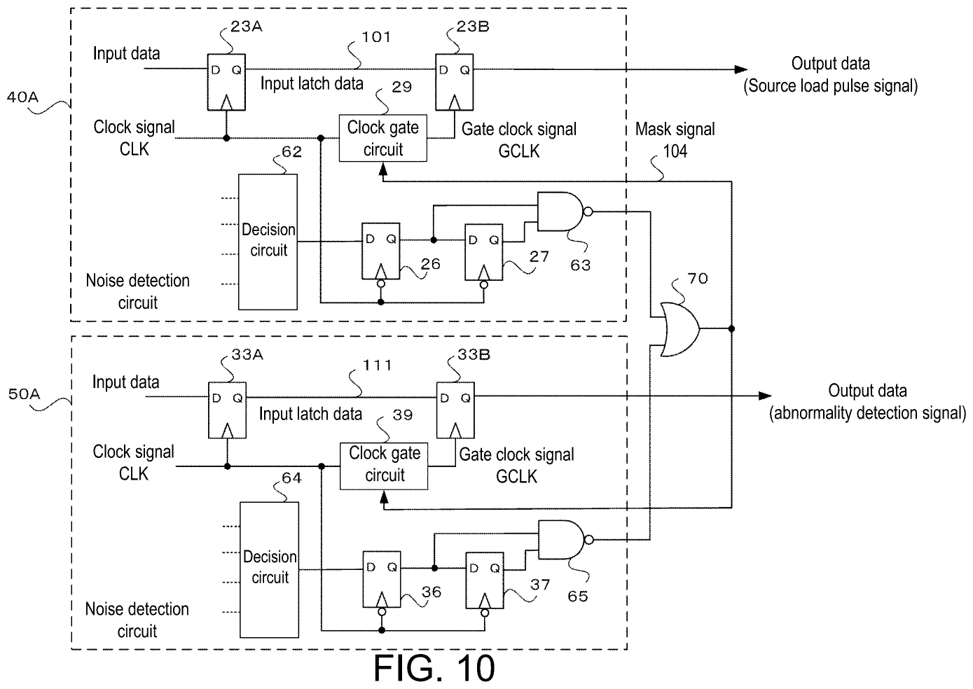

FIG. 10 shows a circuit configuration for the case where cooperative operation is performed by multiple noise detection circuits.

In FIG. 10, a noise detection circuit 40A is provided for the circuit that outputs the source load pulse signal, and a noise detection circuit 50A is provided for the circuit that outputs the abnormality detection signal.

The noise detection circuit 50A has a circuit configuration similar to that of the noise detection circuit 40A, and includes output FF circuits 33A and 33B, a clock gate circuit 39, FF circuits 36 and 37, a decision circuit 64, and a NAND circuit 65. The output FF circuit 33A holds the input data as input latch data 111.

Furthermore, in the circuit configuration shown in FIG. 10, an OR circuit 70 is provided that takes the output signals from NAND circuits 63 and 65 as inputs. The OR circuit 70 performs a logical OR operation on the output signals from the NAND circuits 63 and 65, and outputs the operation result as a mask signal 104. The mask signal 104 output from the OR circuit 70 is input to the clock gate circuits 29 and 39 in the noise detection circuits 40A and 50A, respectively.

In this way, in the circuit configuration shown in FIG. 10, multiple output FF circuits 23A and 33A for holding input data and decision circuits 62 and 64 are provided respectively. Then, two decision circuits 62 and 64 are configured for each of the two output FF circuits 23A and 33A respectively.

Then, the mask control circuit provided in the noise detection circuits 40A and 50A controls such that, in response to a decision result signal indicating an abnormality being output from either one of the two decision circuits 62 and 64, all display control data held in the two output FF circuits 23A and 33A are not output to the display control circuit 12 that performs display control of the display panel 100. In other words, according to the above-described circuit configuration, even if noise generation is detected in either one of the noise detection circuits 40A and 50A, erroneous output of both the source load pulse signal and the abnormality detection signal is prevented.

What is claimed is:

1. A driver circuit that displays received display data on a display panel, the driver circuit comprising:
a first register circuit, holding display control data used for controlling display of the display data on a display panel and outputting the display control data at a predetermined timing;
a plurality of second register circuits, holding decision data with predetermined logic;
a decision circuit, outputting a decision result indicating no abnormality has occurred in response to a logic of decision data held in the plurality of second register circuits being a predetermined logic, respectively, and display control data held in the first register circuit being active; and
a mask control circuit, controlling so that display control data held in the first register circuit is output to a circuit that performs display control of the display panel in response to a decision result output from the decision circuit indicating that no abnormality has occurred.

2. The driver circuit according to claim 1, wherein the mask control circuit controls so that display control data held in the first register circuit is output to a circuit that performs display control of the display panel by allowing a clock signal to be supplied to an output flip-flop circuit for outputting display control data held in the first register circuit in response to a decision result output from the decision circuit indicating that no abnormality has occurred.

3. The driver circuit according to claim 1, wherein the decision data is data comprising at least one of both high level logic and low level logic.

4. The driver circuit according to claim 1, wherein the plurality of second register circuits are configured near the first register circuit.

5. A driver circuit that displays received display data on a display panel, the driver circuit comprising:
a first register circuit, holding display control data used for controlling display of the display data on a display panel and outputting the display control data at a predetermined timing;
a plurality of second register circuits, holding decision data with predetermined logic;
a plurality of third register circuits, holding decision data with predetermined logic different from decision data held in the plurality of second register circuits;
a selection circuit, selecting either decision data held in the plurality of second register circuits or decision data held in the plurality of third register circuits according to a logic of a control signal that controls a timing at which a logic of the display control data switches;
a decision circuit, outputting a decision result indicating no abnormality has occurred in response to a combination of a logic of decision data selected by the selection circuit and a logic of display control data held in the first register circuit matching any of predetermined combinations; and
a mask control circuit, controlling so that display control data held in the first register circuit is output to a circuit that performs display control of the display panel in response to a decision result output from the decision circuit indicating that no abnormality has occurred.

6. The driver circuit according to claim 5, wherein a plurality of the first register circuits and a plurality of the decision circuits are provided respectively,
the plurality of decision circuits are configured for each of the plurality of first register circuits, respectively, and
the mask control circuit controls so that all display control data held in the plurality of first register circuits are not output to a circuit that performs display control of the display panel in response to a decision result indicating that an abnormality has occurred being output from any one of the plurality of decision circuits.

7. An image display system, comprising:
the driver circuit according to claim 1; and
a control circuit, transmitting the display data to the driver circuit.

8. An image display system, comprising:
the driver circuit according to claim 2; and
a control circuit, transmitting the display data to the driver circuit.
